(19) United States
(12) Patent Application Publication
(10) Pub. No.: US 2026/0284836 A1
(43) Pub. Date: Sep. 24, 2026

(54) ADJUSTABLE VISE SYSTEM AND METHOD

(71) Applicant: Mate Precision Technologies Inc., Anoka, MN (US)

(72) Inventor: Nathan HALL, Anoka, MN (US)

(73) Assignee: Mate Precision Technologies Inc., Anoka, MN (US)

(21) Appl. No.: 19/576,795

(22) Filed: Mar. 24, 2026

Related U.S. Application Data
(60) Provisional application No. 63/776,685, filed on Mar. 24, 2025.

(51) Int. Cl. B25B 1/18; B25B 1/02; B25B 1/12

(52) U.S. Cl. CPC B25B 1/18; B25B 1/02; B25B 1/125

(57) ABSTRACT

The present disclosure provides one or more examples of a vise system and method. The vise is an adjustable vise system used for holding a workpiece. In one example, the vise includes a vise body and a cart system positioned within the vise body. The cart system includes a dual jaw pusher, a lead screw, and a cart. The lead screw is operably coupled to the dual jaw pusher, where the lead screw provides gross adjustment to positioning of the dual jaw pusher. The cart is operably coupled to the dual jaw pusher. A piston is coupled to the cart for vertical movement of the cart relative to the vise body, where the dual jaw pusher translates vertical movement from the cart to horizontal movement of the dual jaw pusher.

### CROSS-REFERENCE TO RELATED APPLICATION

This application is a non-provisional of U.S. Patent Application No. 63/776,685 filed Mar. 24, 2025, which is incorporated herein by reference.

### BACKGROUND

The present disclosure relates generally to examples of a vise for holding a workpiece.

Work piece clamping is achieved through either manual user input or by automatic methods. Manual work holding designs generally benefit from an ability to adapt to a wide range of different sized work pieces with little to no effort. Automatic clamping methods benefit from the ability to be automated, allowing for faster out of cycle times. Each lacking what the other generally would provide. A combination work holding device would alleviate the issues of both while maintaining the benefits of the two individual styles.

For these and other reasons, a need exists for the claimed subject matter.

### SUMMARY

The present disclosure provides one or more examples of a vise system and method. In examples, the present disclosure provides one or more examples of a vise system that is an adjustable centering vise.

In one example, the vise system is an adjustable pneumatic centering vise with both gross and clamping adjustment features.

In one example, the vise system is a work holding design that utilizes a cart and wedge combination system to allow for gross adjustability in combination with pneumatic automation capabilities. A piston attached to the cart system is driven up and down via pneumatics actuating against a dual pusher assembly with jaw faces driving the clamping motion. Course or large scale adjustments can be made either manually or automatically via a lead screw.

One example provides an adjustable vise. The vise includes a vise body and a cart system positioned within the vise body. The cart system includes a dual jaw pusher, a lead screw, and a cart. The lead screw is operably coupled to the dual jaw pusher, where the lead screw provides gross adjustment to positioning of the dual jaw pusher. The cart is operably coupled to the dual jaw pusher. A piston is coupled to the cart for vertical movement of the cart relative to the vise body, where the dual jaw pusher translates vertical movement from the cart to horizontal movement of the dual jaw pusher.

Additional and/or alternative features and aspects of examples of the present technology will become apparent from the following description and the accompanying drawings.

### BRIEF DESCRIPTION OF THE DRAWINGS

The Figures generally illustrate one or more examples of a a vise system.

FIG. 1 is a diagram illustrating one example of an adjustable vise.

FIG. 2 is a diagram illustrating one example of an end view an adjustable vise.

FIG. 3 is a diagram illustrating one example of a side view of an adjustable vise.

FIG. 4 is a diagram illustrating one example of a side view of an adjustable vise in cross-section.

FIG. 5 is a diagram illustrating one example of a cart assembly of an adjustable vise in perspective view.

FIG. 6 is a diagram illustrating one example of a top view of the cart assembly of FIG. 5.

FIG. 7 is a diagram illustrating one example of an end view of the cart assembly of FIG. 5.

FIG. 8 is a diagram illustrating one example of a perspective view of an adjustable vise.

FIG. 9 is a diagram illustrating one example of a perspective view of an adjustable vise cart assembly.

FIG. 10 is a diagram illustrating one example of a side view of the cart assembly of FIG. 9.

FIG. 11 is a diagram illustrating one example of a vise dual pusher.

FIG. 12 is a diagram illustrating one example of a side view of a vise dual pusher.

FIG. 13 is a diagram illustrating one example of a dual pusher, including the interaction between the lower pusher and the upper pusher.

FIG. 14 is a diagram illustrating one example of a dual pusher, including the interaction between the lower pusher and the upper pusher.

FIG. 15 is a diagram illustrating one example of a vise holding piece-parts or workpieces.

FIG. 16 is a diagram illustrating one example of a vise suitable for holding piece-parts or workpieces.

FIG. 17 is a diagram illustrating one example of a vise configured as illustrated in FIG. 16.

FIG. 18 is a diagram illustrating one example of a method of operating a vise.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The present disclosure provides one or more examples of a vise system and method. In examples, the present disclosure provides one or more examples of a vise system that is an adjustable centering vise.

The vise system is an adjustable centering vise with both gross adjustment and fine adjustment features. In one example, gross adjustment on a workpiece is achieved using a lead screw assembly. Fine adjustment is achieved using a cart in combination with a dual pusher. The fine adjustment operates to lock or tension the vise against the workpiece, securely holding the workpiece.

When describing the vise according to the present specification, the terms adjustment, movement, or force are used interchangeably herein. For example, a movement imparted to a dual pusher or jaw is a force imparted to a dual pusher or jaw.

In one example, the vise system is a work holding design that utilizes a cart system to allow for gross adjustability in combination with automation tensioning and clamping capabilities. In one example, a piston attached to the cart system is driven up and down via pneumatics actuating against a dual pusher assembly with wedged faces driving the clamping motion. The adjustments can be made either manually or automatically via the lead screw.

The main body is for housing both the piston chamber as well as the cart system. The cart system is comprised of a lead screw assembly: lead screw, center support, lower pusher, and upper pusher. The lead screw is used to adjust to the preferred size of work piece for clamping. The piston, when actuated via pneumatics, pulls down on the cart system. It is recognized that other actuator mechanisms can be used to move the cart system. For example, the cart system can be pulled down using an incompressible fluid system.

As the cart system is pulled down the lower pusher reacts against the upper pusher via an angled surface to transition the direction of the force and motion from a downward one to an inward clamping. The upper pushers remain level due to the main body supporting them allowing for only the inward/outward clamping motion. The lower pushers also resist a change in their positions horizontally due to the threads on the lead screw as well as the cart itself.

The following figures illustrate one or more examples of a vise system according to the present disclosure in further detail.

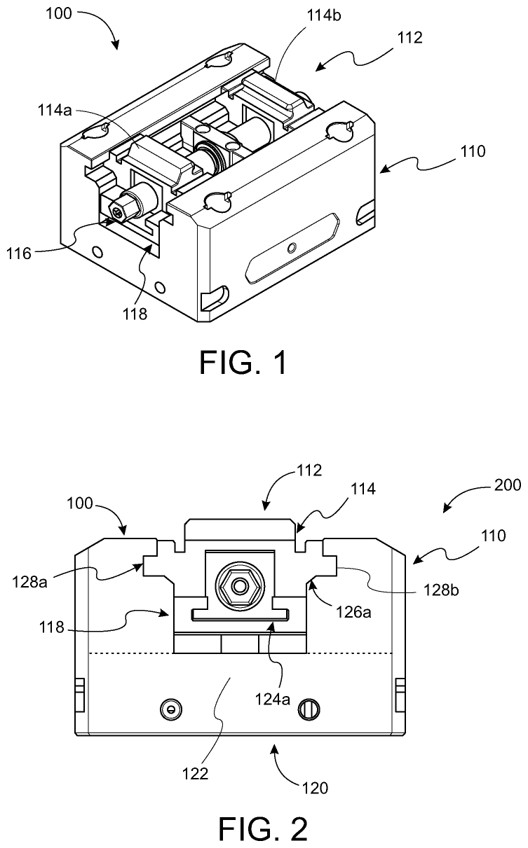

FIG. 1 is a diagram illustrating one example of an adjustable vise, indicated at 100. The vise 100 includes a vise body 110 and a cart system 112. The cart system 112 is at least partially located within the vise body 110. The cart system 112 includes a first dual jaw pusher 114a and a second dual jaw pusher 114b, a lead screw assembly 116, and a cart 118. The lead screw assembly 116 is operationally coupled to the dual jaw pushers 114a, 114b for gross adjustment of the vise. Each dual jaw pusher 114a, 114b are two piece jaw pushers. The cart 118 is operationally coupled to the first dual jaw pusher 114a and second dual jaw pusher 114b for fine adjustment of the dual jaw pushers on the vise 100.

In one example, the cart 118 operably holds the dual jaw pushers 114a and 114b, and the lead screw assembly 116. The cart 118 is an interface between the a mechanical drive assembly 120 (e.g., a piston 122) and the cart system 112. In one example, a jaw (e.g., a reversible jaw) is positioned on the first dual jaw pusher 114a and the second dual jaw pusher 114b (not shown in FIG. 1), and the gross and fine adjustment features are used for holding a workpiece (also not illustrated in FIG. 1) by the vise 100.

FIG. 2 is a diagram illustrating one example of an end view the vise 100, indicated at 200. In one example, the vise 100 includes the mechanical assembly 120 operationally coupled to the cart 118, to aid in fine adjustment of the dual jaw pushers 114a, 114b. Although only dual jaw pusher 114a is detailed in this view, the detailed description of dual jaw pusher 114a also applies to dual jaw pusher 114b. The mechanical assembly 120 operates to move cart 118 up or down in a vertical direction, resulting in inward or outward movement of each dual jaw pusher 114a, 114b in a horizontal direction along a length of the vise 100. The mechanical drive assembly 120 is positioned within a bottom portion of the vise body 110. In one example, the mechanical drive assembly is a piston 122. Although the piston further detailed herein is a pneumatically actuated piston, it is recognized that it also could be a hydraulically actuated piston. Additionally, other mechanical mechanisms can be used for mechanical assembly 120 for controlled movement of cart 118 up or down in a vertical direction.

The dual jaw pusher 114a includes a lower pusher 124a and an upper pusher 126a. The lower pusher 124a is slotted within cart 118. The upper pusher 126a is movably positioned within slots 128a, 128b located in the sides of vise body 110. The lower pusher 124a is movably coupled to the upper pusher 126a. Further, since an angled sidewall interface exists between the lower pusher 124a and the upper pusher 126a, movement of the lower pusher 124a in a vertical direction results in movement of the upper pusher 126a in a horizontal direction. The dual pusher 114a translates vertical input movement to horizontal movement of the dual pusher 114a, and in particular 126a. Interaction between the lower pushers 124a, 124b and the upper pushers 126a, 126b is described in detail further in this specification.

FIG. 3 is a diagram illustrating one example of a side view of adjustable vise 100, indicated at 300. The cart system 112 nests within the vise body 110. Center support 130 is illustrated. Center support 130 mechanically couples lead screw assembly 116 to cart 118. First dual jaw pusher 114a and second dual jaw pusher 114b are further illustrated in side view. Piston head (i.e., piston plate) 136, including chamber 134 is also illustrated. Piston head 136 is moved vertically within chamber 134, resulting in horizontal movement (inward or outward movement) of jaw pusher 114a and jaw pusher 114b. In operation, a pneumatic system 131 operates at air entry 132 to move air in and out of chamber 134 for movement of the piston head.

Rotation of lead screw assembly 116, indicated by rotational arrow 116a, results in horizontal movement of jaw pushers 114a, 114b, illustrated by the horizontal arrows. The rotation of lead screw assembly 116 can be accomplished manually or through automation. In one example, rotation 116a of lead screw assembly 116 in a first direction results in inward movement of jaw pusher 114a, indicated at 114c, and inward movement of jaw pusher 114b, indicated at 114d, towards center support 130. In this manner, the jaw pushers 114a, 114b can be moved to position a jaw for holding a workpiece. Rotation 116a of lead screw assembly 116 in a second direction results in outward movement of jaw pusher 114a, indicated at 114e, and outward movement of jaw pusher 114b, indicated at 114f, away from center support 130 (e.g., to release a workpiece).

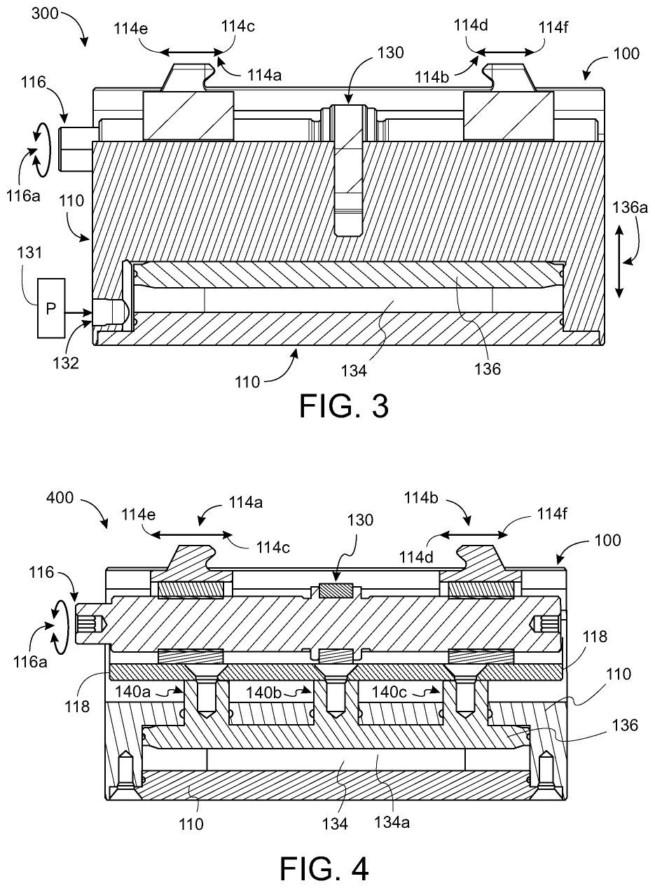

FIG. 4 is a diagram illustrating one example of another side view of adjustable vise 100 in cross-section, indicated at 400. Cart 118 is securely connected to piston head 136 for movement of cart 118 in a vertical direction during operation of the vise 100. In one example, cart 118 is mechanically coupled to piston head 136, indicated at screw connections 140a, 140b, and 140c. When piston head 136 is pneumatically operated, O-ring seals 145 allow for movement of piston head 136 without releasing air from chamber 134.

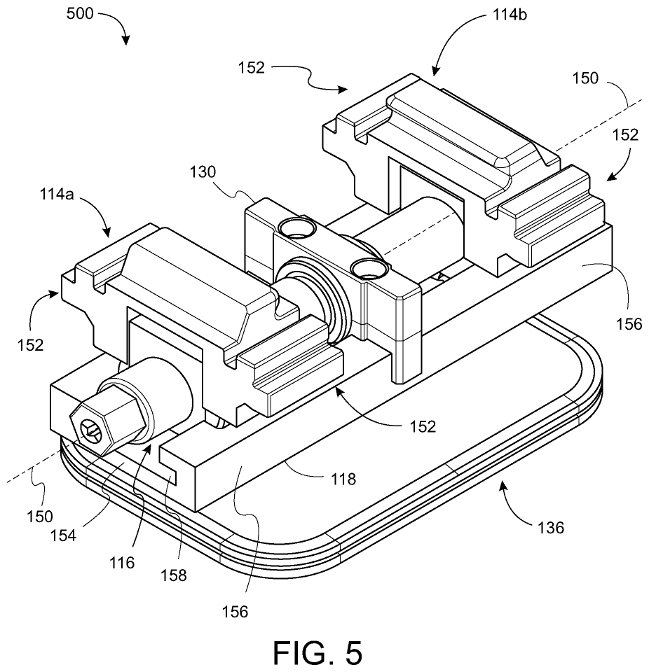

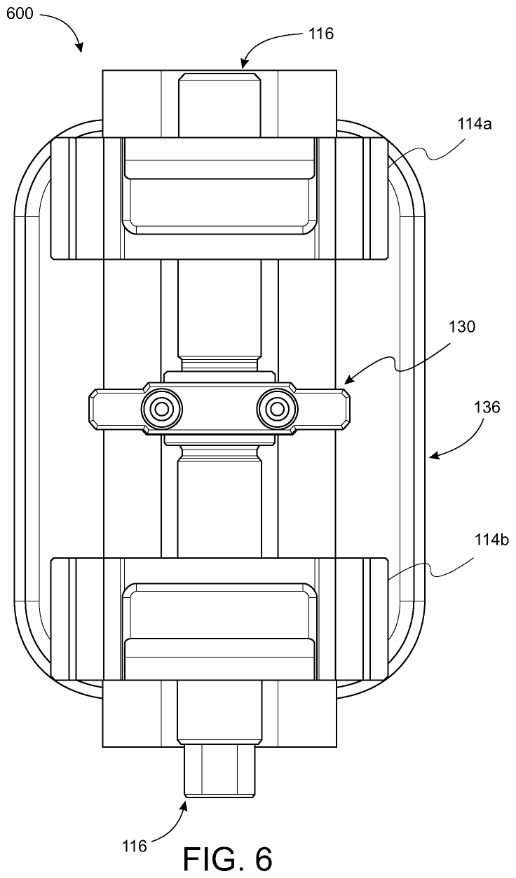

FIG. 5 is a diagram illustrating one example of a cart assembly of an adjustable vise in perspective view, indicated at 500. FIG. 6 is a diagram illustrating one example of a top view of the cart assembly of FIG. 5, indicated at 600. The cart assembly 112 is attached to piston head 136 as previously illustrated herein. In one example, cart 118 is mechanically coupled to piston head 136. Center support 130 provides a vertical guide to the cart system 112, and sits within vertical slots located in the inner sidewalls of the vise body 110. The cart system 112 is designed to be movably located within vise body 110.

The cart system 112 is made up of dual jaw pusher 114a and dual jaw pusher 114b, lead screw assembly 116, and cart 118. Rotational operation of lead screw assembly 118 horizontally moves dual pushers 114a, 114b in an inward or outward direction along longitudinal axis 150. Dual pusher 114a includes lower pusher 124a and upper pusher 126a. Dual pusher 114b includes lower pusher 124b and upper pusher 126b. The lead screw assembly 116 extends through lower pusher 124a, center support 130, and lower pusher 124b. Rotational operation of lead screw assembly 116 in a rotational direction moves lower pusher 126a and lower pusher 126b in an inward direction. Rotational operation of lead screw assembly 116 in an opposite rotation direction moves lower pusher 126a and lower pusher 126b in an outward direction. Upper pusher 126a and upper pusher 126b include rail system 152 guide rails for precise horizontal movement of jaw pusher 114a and jaw pusher 114b within vise body 110.

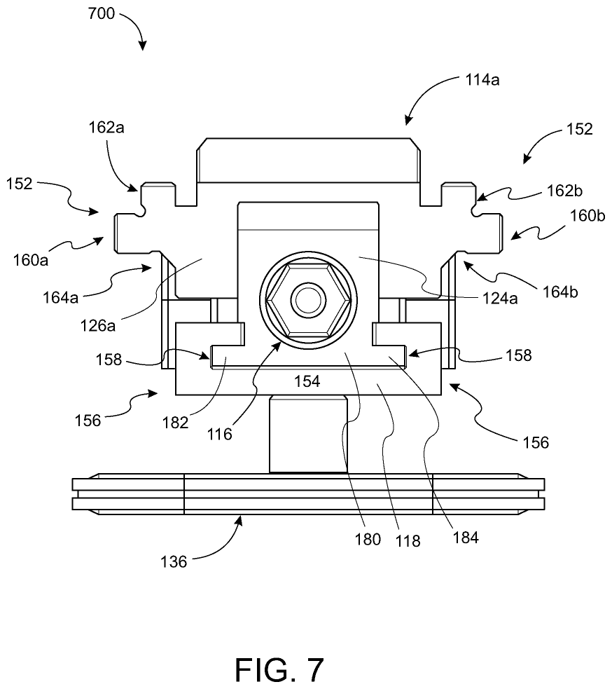

FIG. 7 is a diagram illustrating one example and end view of the cart assembly of FIG. 5, indicated at 700. Cart 118 is coupled to piston head 136. Cart 118 includes a cart body 154 including cart sidewalls 156. The cart 118 extends longitudinally along the entire cart system 112 (See, for example, FIG. 5). In one example, the cart body 154 has the shape of a generally rectangular plate. The cart sidewalls 156 are located at each edge of the generally rectangular shaped plate. In one example, the cart sidewalls 156 are u-shaped, and extend inward along an outside edge of the cart 118. This results in a cart slot 158. A cart slot 158 extends longitudinally along each side edge of the cart 118. Lower pusher 124a includes a bottom member 180. The bottom member 180 includes a first outwardly extending longitudinal flange 182 and a second outwardly extending longitudinal flange 184. Flange 182 and flange 184 extend along the bottom edge of lower pusher 124a. The flange 182 and flange 184 fit withing cart slot 158 on each side of the cart 118.

Lead screw assembly 116 extends through the center of lower pusher 124a. Upper pusher 126a is movably coupled to lower pusher 124a. In one example, an angled sidewall interface exists between lower pusher 124a and upper pusher 126a. The movable connection between lower pusher 124a and upper pusher 126a is described in detail later in this specification.

Upper pusher 126a is movably connected to the vise body 110. Vise body 110 includes a pusher slots 128a, 128b, indicated in FIG. 2. The pusher slots 128a, 128b extend longitudinally along each inner side of the vise body 110. Upper pusher 126a includes an outwardly extending flange on each side of the upper pusher 126a, indicated as flange 160a and flange 160b. Each flange 126a,126b has a generally rectangular shaped edge the fits (i.e., slots) inside the corresponding vise pusher slots 128a, 128b. A rail 162a, 162b extends upward on each side of the upper pusher 126a. The rails 162a, 162b function to provide a guiding edge to the upper pusher 126a when located within the vise body 110. In one example, the upper pusher 126a includes a pusher edge 164a on the bottom side of the flange 160a, and a pusher edge 164b on the bottom side of the flange 160b. Pusher edges 164a, 164b are multifaceted edges that further aid in guiding pusher flange 160a and pusher flange 160b within the corresponding pusher slots 128a, 128b.

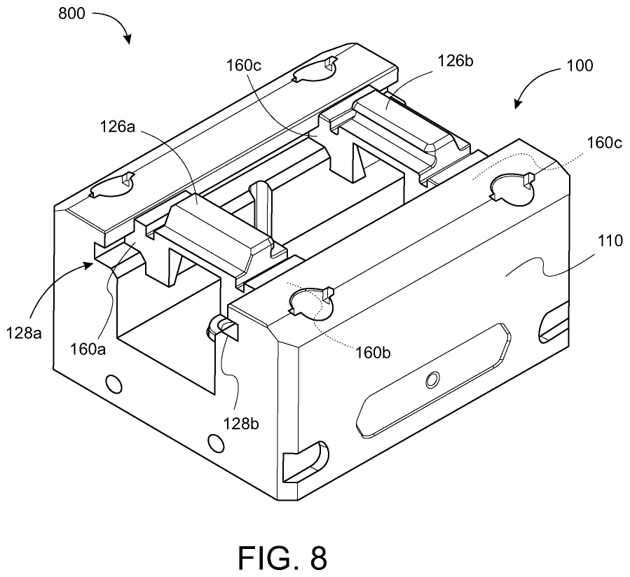

FIG. 8 is a diagram illustrating one example of a perspective view of vise body 110 with one or more upper jaw pushers positioned therein, indicated at 800. The vise body 110 includes upper pusher 126a and upper pusher 126b contained therein. Upper pusher 126a and upper pusher 126b are movably coupled to vise body 110 using the pusher slots 128a, 128b. In one example, vise body 110 includes a pusher slot 128a that extends longitudinally along a first interior side of the vise body 110, and a pusher slot 128b that extends along a second interior side of the vise body 110. Upper pusher 126a includes flange 160a positioned within pusher slot 128a and flange 160b positioned within pusher slot 128b (not shown in the view illustrated). Upper pusher 126b includes flange 160d positioned within pusher slot 128a and flange 160b positioned within pusher slot 128b (not directly shown but illustrated in dashed lines).

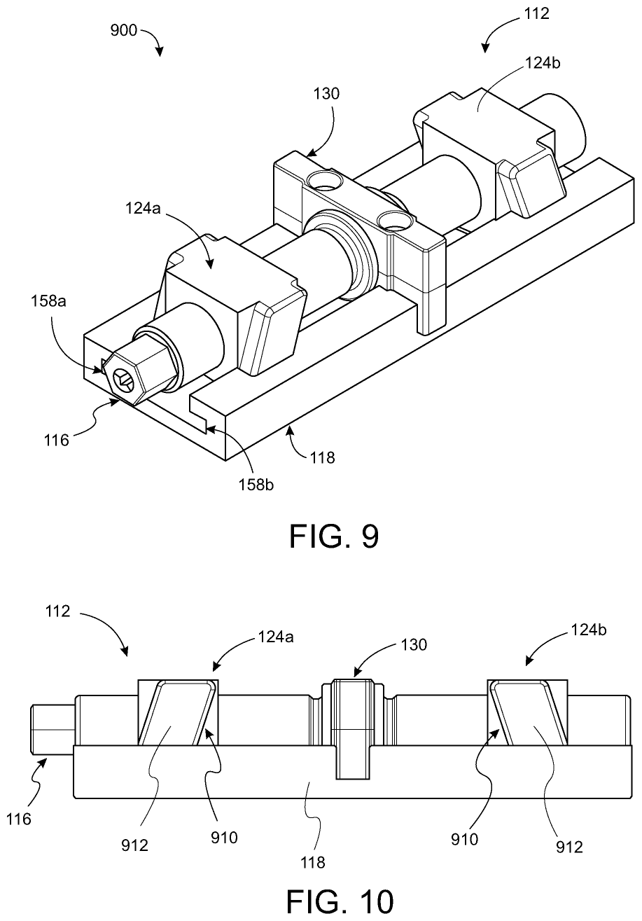

FIG. 9 is a diagram illustrating one example of a perspective view of a vise cart system 112, indicated at 900. FIG. 10 is a diagram illustrating one example of a side view of the cart system 112 of FIG. 10. The vise cart system 112 is illustrated without the upper pusher 126a or upper pusher 126b positioned on the cart system 112. Lower pusher 124a and lower pusher 124b are positioned within the cart system 112, including being positioned within cart slot 158. Lead screw assembly 116 extends through lower pusher 124a, lower pusher 124b, and center support 130.

One example of the lower pushers 124a, 124b angled sidewall interface structure is illustrated at 910. Each lower pusher 124a, 124b angled sidewall interface structure includes an angled slide member 912 for slidable connection with a corresponding slot in the corresponding upper pusher. One example of a dual jaw pusher is detailed in reference to dual jaw pusher 114a and is detailed in the following figures. The detailed description of the angled sidewall interface structure 910 between lower pusher 124a and upper pusher 126a also applies to the angled sidewall interface structure between the lower pusher 124b and the upper pusher 126b. The angled sidewall interface structure between the lower pusher and the upper pusher translates vertical movement of the lower pusher to horizontal movement of the upper pusher. Further, since the angled slide member 912 for each lower pusher is angled inward towards the center support 130, movement of the lower pushers 124a, 124b in a downward vertical direction results in movement of corresponding upper pushers in a horizontal inward direction. Movement of the lower pushers 124a, 124b in an upward vertical direction results in movement of corresponding upper pushers in an outward horizontal direction relative to center support 130.

In another example, the dual jaw pushers and jaws positioned thereon are reversible jaw pushers that are configured in a reverse position than is shown. As such, vise 100 can be used with other workpiece configurations. If desired for a specific application, the dual jaw pushers (e.g., dual jaw pusher 114a and dual jaw pusher 114b) can be reversed, resulting in the jaw pushers positioning and holding a piece-part using a force in an outward direction. Specifically, in a reversed position the angled slide members are angled outward away from center support 130. A force or movement of the lower pushers 124a, 124b in a downward vertical direction translates to movement of corresponding upper pushers in a horizontal outward direction.

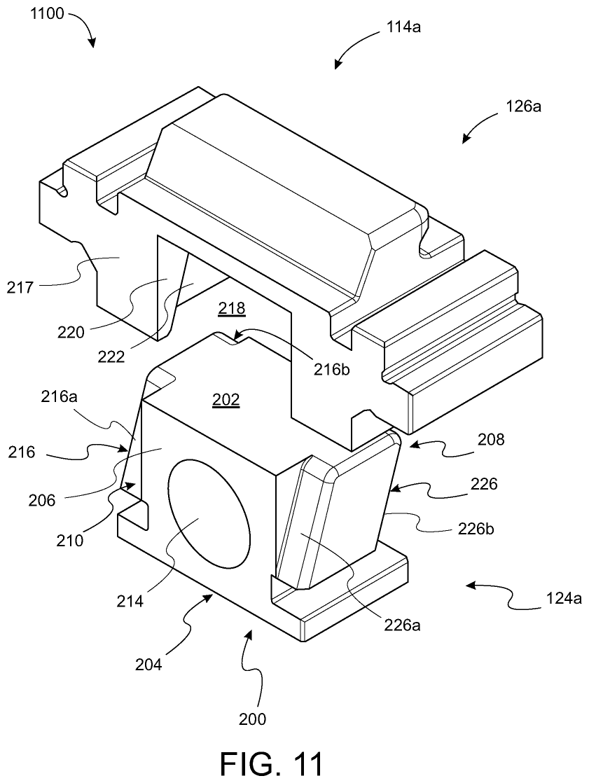

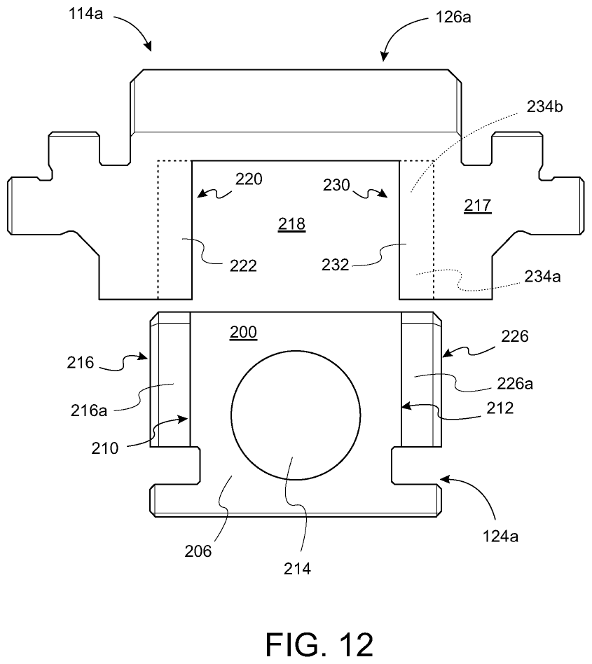

FIG. 11 is a diagram illustrating one example of vise dual jaw pusher, indicated at 1100. FIG. 12 is a diagram illustrating one example of an end view of the dual jaw pusher of FIG. 11. The dual jaw pusher includes a lower pusher and an upper pusher. In one example, the dual jaw pusher illustrated herein is jaw pusher 114a.

Lower pusher 124a includes a generally rectangular shaped body 200, having an upper surface 202, a lower surface 204, a first side face 206, a second side face 208, a third side face 210, and a fourth side face 212. Opening 214 extends between first side face 206 and second side face 208. In use, lead screw assembly 116 extends through the opening 214.

Third side face 210 includes slide member 216. Slide member 216 extends outwardly from third side face 210. In one example, slide member 216 is similar to angled slide member 910 previously detailed herein and includes angled sidewalls 216a and 216b having angled surfaces. Upper pusher 126a includes a body 217 having interior opening 218 for receiving lower pusher 124a. The interior opening 218 includes interior sidewall 220 having angled slot 222 sized to receive slide member 216. The slot 222 includes angled sidewalls 224a, 224b for receiving slide member 216.

Fourth side face 212 includes slide member 226. Slide member 226 extends outwardly from fourth side face 212. In one example, slide member 226 is an agled slide member, and includes angled sidewalls 226a and 226b (hidden) having angled surfaces. Upper pusher 126a includes body 217 with interior opening 218 for receiving lower pusher 124a. The interior opening 218 includes interior sidewall 230 having slot 232 sized to receive slide member 226. The slot 232 includes angled sidewalls 234a, 234b (shown in dashed arrows) for receiving slide member 226.

In operation, moving the lower pusher 124a relative to the upper pusher 126a in a vertical up or down manner, results in the upper pusher 126a moving horizontally relative to the lower pusher 124a. The translation of vertical movement to horizontal movement is accomplished using the angled sidewall interface structure having a slotted design as detailed herein with angled side surfaces. In one example illustrated herein, when the lower pusher 124a is pulled downward, the resulting movement of the upper pusher 126a in an inward movement in a horizontal direction towards the vise center plate and providing secure clamping of a workpiece.

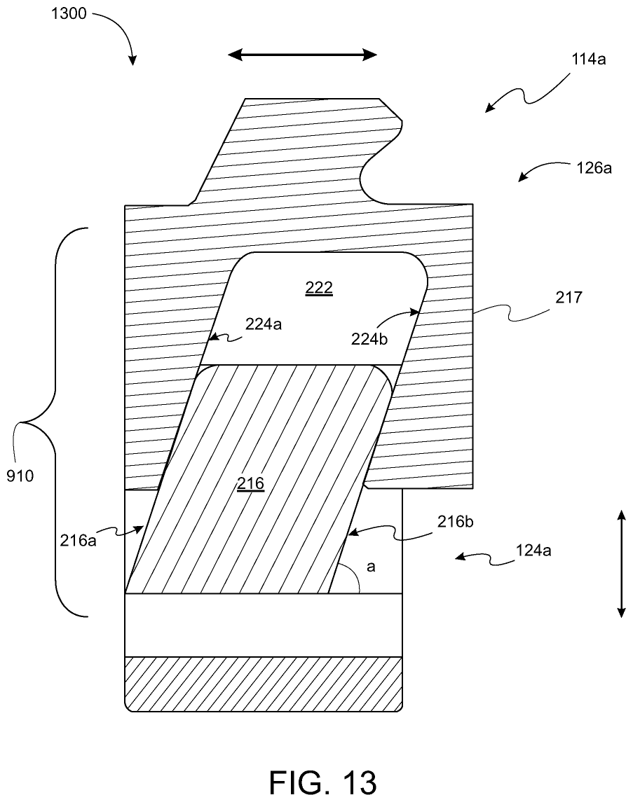

FIG. 13 is a diagram illustrating one example of a dual jaw pusher, including the interaction between the lower pusher and the upper pusher, indicated at 1300. The dual jaw pusher illustrated is dual jaw pusher 114a. One example of the angled sidewall interface structure is illustrated at 910. The angled sidewall interface structure provides translation of vertical movement of the lower pusher to horizontal movement of the upper pusher.

In this example, the lower pusher is illustrated at 124a. The upper pusher is illustrated at 126a. The upper pusher 126a is shown positioned on the lower pusher in a first position using angled sidewall interface structure 910. In one example, the angled sidewall interface structure 910 includes lower pusher 124a having slide member 216 extending from side face 210. The slide member 216 includes angled sidewall 216a and angled sidewall 216b. Upper pusher 126a includes slot 222 having a slot opening that matches the slide member 216. Slot 222 includes angled sidewall 224a and angled sidewall 224b.

Upper pusher 126a is illustrated positioned on lower pusher 124a. In operation, vertical movement of lower pusher 124a in an upward or downward manner, indicated by vertical arrow 1310, results in horizontal movement of upper pusher 126a, indicated by a horizontal movement arrow 1320. Due to the angled sidewall interface structure 910, vertical movement of the lower pusher 124a results in movement of angled slide member 216 within corresponding angled slot 222. In one example illustrated, pulling the lower pusher 124a downward 1310a in a vertical direction translates to movement of the upper pusher 126a in in an inward horizontal direction 1320a. Pushing the lower pusher 124a upward in a vertical direction 1310b results in movement of the upper pusher 124a in an outward horizontal direction 1320b.

In one example, the an operational angle a exists relative to the horizontal direction of angled sidewall interface structure. In one example, the operation angle a value is within a range of 6-45 degrees. Other operational values may be used. It is recognized that the operational angle a value is only limited by the desired amount of displacement between the lower pusher 124a and the upper pusher 126a.

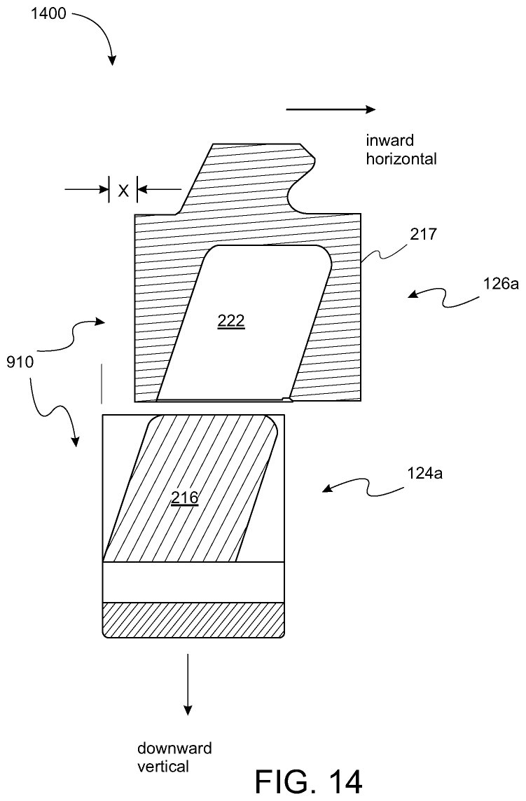

FIG. 14 is a diagram illustrating one example of a dual jaw pusher, including the interaction between the lower pusher and the upper pusher, indicated at 1400. The dual jaw pusher illustrated is dual jaw pusher 114a, and is shown in a second position. One example of the angled sidewall interface structure is illustrated at 910. The angled sidewall interface structure provides translation of vertical movement of the lower pusher to horizontal movement of the upper pusher.

In the example illustrated, in the second position the lower pusher 124a of dual jaw pusher 114a has been pulled vertically downward, indicated by downward vertical arrow 410. Due to the angled sidewall interface structure 910, this results in an inward horizontal movement of the upper pusher 126a, and a horizontal displacement X between the lower jaw pusher 124a and the upper jaw pusher 126a.

It is recognized that the vise in accordance with the present disclosure is used for securely retaining a workpiece. In one example, the vise lead screw assembly is used for gross positioning of the vise to a workpiece, and the cart assembly including the dual jaw pusher design is used for fine positioning, clamping or tensioning of a jaw on a workpiece. In one example, the dual jaw pusher design having an angled sidewall interface structure is used for secure final tensioning of the vise against the workpiece.

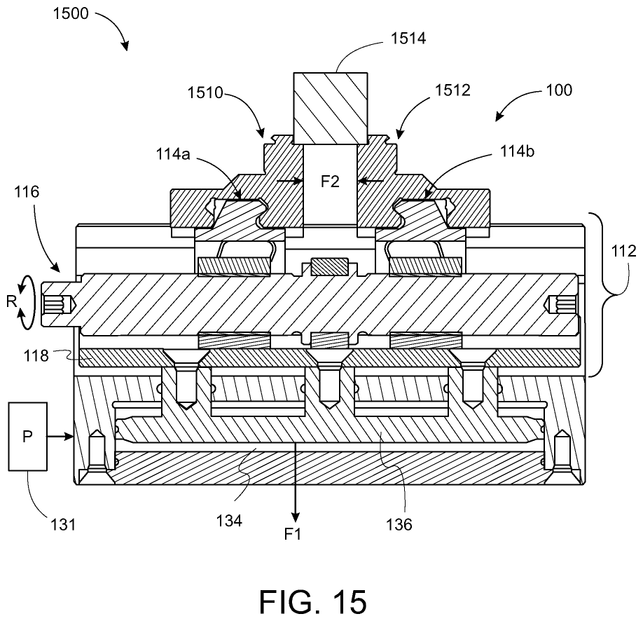

FIG. 15 is a diagram illustrating one example of vise 100 holding piece-parts or workpieces, indicated generally at 1500. Vise 100 is securely and accurately holding a piece-part 1514 for machining.

A first jaw 1510 is positioned on dual jaw pusher 114a. A second jaw 1512 is positioned on dual jaw pusher 114b. Piece-part 1514 is held securely between first jaw 1510 and second jaw 1512. An inward tension or force F provided by first jaw 1510 and second jaw 1512 holds the piece-part 1514 securely in place for machining. In one or more examples, the first jaw 1510 and the second jaw 1512 are removably coupled to dual jaw pusher 114a and dual jaw pusher 114b. Additionally, first jaw 1510 and second jaw 1512 have a reversible jaw design for providing alternate configurations for securely retaining a piece-part. One example of a reversible jaw design suitable for use with the present vise is disclosed in U.S. Pat. No. 11,759,914 , the disclosure of which is incorporated herein by reference.

In operation, the vise 100 has a dual adjustment mode. In the first adjustment mode, gross adjustment (i.e., large scale) is provided by rotation the lead screw to move the dual jaw pushers 114a and 114b inward (i.e., providing an inward force), resulting in moving jaw 1510 and jaw 1512 inward to retain piece-part 1514. In the second adjustment mode, clamping adjustment is provided by the cart assembly 112. Pneumatic system 131, including piston 136 located within chamber 134, provides a pull-down force to cart 118. Cart 118 is coupled to dual jaw pusher 114a and 114b. Dual jaw pushers 114a and 114b are two piece jaw pushers, and each include a lower pusher and an upper pusher. Providing a pull-down force (a vertical downward force) on the lower pushers tanslates to an inward tensioning or clamping force provided by the upper pushers due to the angled sidewall interface structure between the lower pusher and corresponding upper pusher. Accordingly, in the second mode dual jaw pusher 114a and dual jaw pusher 114b impart an inward movement or final tensioning force (i.e., clamping force) to jaws 1510 and 1512 for secure holding of piece-part 1514. The dual jaw pusher 114a, dual jaw pusher 114b, lead screw 116, and cart 118 are all located on a common cart system 112 within the vise body 110.

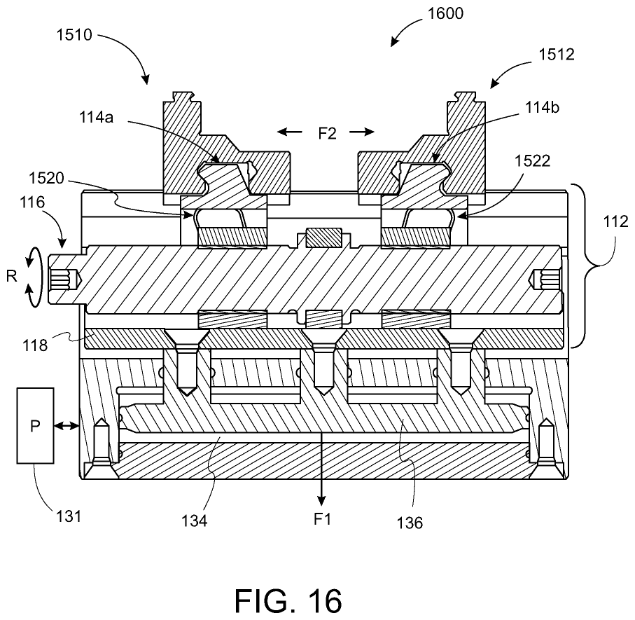

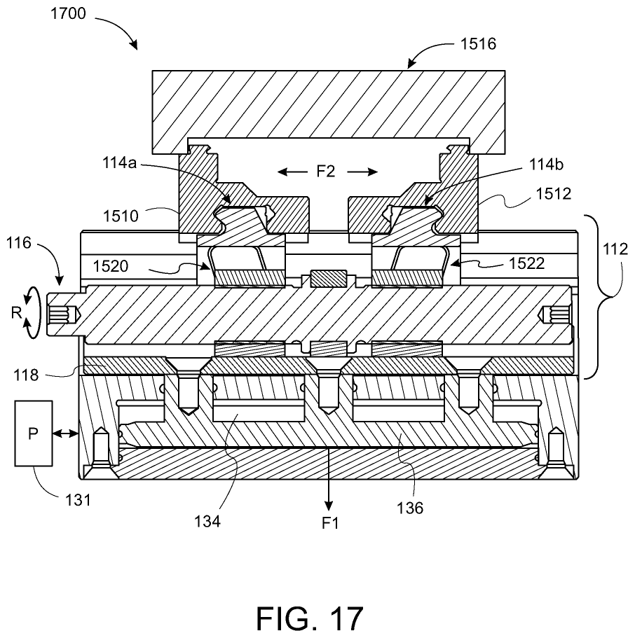

FIG. 16 is a diagram illustrating one example of vise 100 suitable for holding piece-parts or workpieces, indicated generally at 1600. FIG. 17 is a diagram illustrating one example of the vise 100 configured as illustrated in FIG. 16, using outward forces to hold a piece-part. As illustrated, vise 100 is configured similar to the vise of FIG. 15, except that the vise 100 imparts an outward force on a piece-part retained by the vise 100.

The vise 100 is able to impart outward forces to retain a piece part by making simple changes to the vise configuration. In one example illustrated, the dual pushers 114a and 114b are reversible dual pushers. Correspondingly, the jaws positioned on the dual pushers, illustrated as jaw 1510 and jaw 1512 are reversible jaws. As illustrated, dual jaw pusher 114a is configured in a reverse position in the cart assembly 112. Dual jaw pusher 114b is configured in a reverse position in the cart assembly 112. This results in the angled sidewall structure between each dual jaw upper pusher and lower pusher being angled in an outward manner (as illustrated at 1520 and 1522). A pull-down force on cart 118 that is attached to the lower pusher of each dual jaw pusher 114a and 114b now results in an outward horizontal movement or force imparted by the corresponding upper pushers.

In operation, the lead screw 116 is first rotated to move such that the jaws 114a and 114b move the jaws 1510 and 1512 outward for gross positioning of the jaws on workpiece 1516. Next, the pneumatic system 131 imparts a downward force F1 to the lower pushers of dual pusher 114a and 114b (through piston head 136 and cart 118). Since the dual pushers 114a and 114b are positioned in a revers configuration within the cart system 112 and the vise body, an outward force F2 is imparted to piece-part 1516 through reverse mounted dual jaw pushers 114a and 114b, and corresponding jaws 1510 and 1512. The final force provided using the pneumatic system 131 provides a final outward tensioning or clamping force to the jaws 1510 and 1512 for securely retaining the piece-part 1516 for machining of the piece-part.

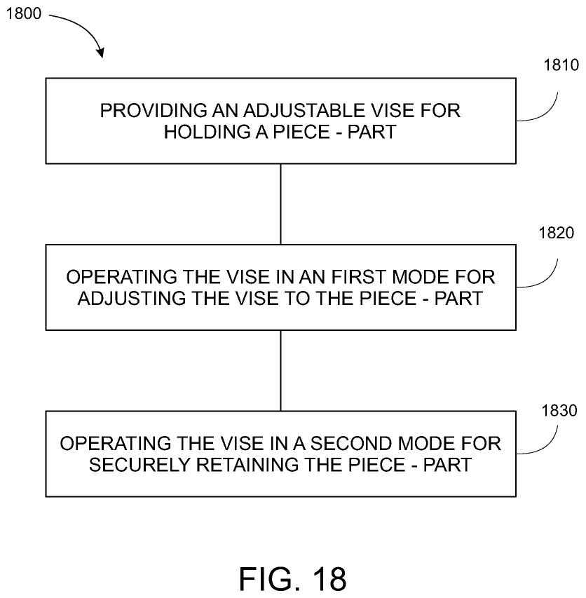

FIG. 18 is a diagram illustrating one example of a method of operating a vise, indicated at 1700.

At 1810, the method includes providing an adjustable vise for holding a piece part. Examples of the adjustable vise are disclosed herein.

In one or more examples, the vise includes a vise body and a cart system located within the vise body. The cart system includes a first dual jaw pusher, a second dual jaw pusher, and a cart. The cart is coupled to the first dual jaw pusher and the second dual jaw pusher. The first dual jaw pusher and the second dual jaw pushers are two piece jaw pushers and each includes a lower pusher and an upper pusher. An angled sidewall interface structure is provided between the lower pusher and the upper pusher. Vise jaws are located on each dual jaw pusher.

At 1820, the method includes operating the vise in a first mode for adjusting the vise to the piece-part. The first mode is a gross adjustment mode. In one example, the first mode includes rotating the lead screw, either manually or automatically, for gross adjustment of the vise jaws on the piece part.

At 1830, the method includes operating the vise in a second mode for securely retaining the piece-part. The second mode is a tensioning and clamping mode. The vise securely and accurately retains the piece-part for machining. In one example of the second mode, a vertical force is imparted by the cart on the lower pusher of each dual jaw pusher. This results in a final horizontal tensioning force imparted by the jaws (via the upper pushers) on the piece-part for securely retaining the piece part.

One or more examples are illustrated in the following paragraphs. It is recognized that multiple examples can be combined and be within the scope of the present application.

Example 1 provides a vise. The vise comprises a vise body and a dual jaw pusher. A lead screw is operably coupled to the dual jaw pusher, the lead screw provides gross adjustment to positioning the dual jaw pusher. A cart is operably coupled to the dual jaw pusher. A piston is coupled to the cart for vertical movement of the cart relative to the vise body, and where the dual jaw pusher translates vertical movement from the cart to horizontal movement of the dual jaw pusher.

Example 2 includes the dual jaw pusher comprising an upper pusher and a lower pusher, where the lower pusher is coupled to the cart.

Example 3 includes an interface between the upper pusher and the lower pusher defined as an angled sidewall interface structure.

Example 4 includes the vise of example 3, where the upper pusher is movably coupled to the lower pusher at the angled sidewall interface structure, and where the angled sidewall interface structure translates vertical movement of the lower pusher to horizontal movement of the upper pusher.

Example 5 includes the vise of example 2, the lower pusher including a side face having an angled slide member, the upper pusher including an interior sidewall having an angled slot for receiving the angled side member.

Example 6 includes the vise of example 5, the side face having a first angled sidewall, and the angled slot having a second angled sidewall, where the first angled sidewall substantially matches the second angled sidewall such that the angled slide member is movably positioned within the angled slot.

Example 7 includes the vise of example 1, where the cart extends longitudinally along a length of the vise.

Example 8 includes the vise of example 1, the dual jaw pusher including an upper pusher and a lower pusher, where the lower pusher is at least partially contained within the cart.

Example 9 includes the vise of example 8, the cart body with generally inwardly facing, u-shaped cart sidewalls, and where the lower pusher includes a lower pusher extension that fits within the u-shaped cart sidewalls.

Example 10 includes the vise of example 8, where the lead screw is operably coupled to the lower pusher.

Example 11 includes the vise of example 1, comprising a jaw operably positioned on the dual jaw pusher.

Example 12 includes the vise of example 1, the vise body including an air chamber, where the piston includes a piston head that moves vertically within the air chamber, and where the piston head is coupled to the dual pusher via the cart.

Example 13 provides a vise. The vise comprises a vise body and a cart system. The cart system is positioned within the vise body. The cart system comprises a lead screw, a first dual jaw pusher and a second dual jaw pusher and a cart. The first dual jaw pusher and the second dual jaw pusher are operably positioned on the lead screw, where upon rotation of the lead screw in a first direction the first dual jaw pusher and the second dual jaw pusher move inward for holding a workpiece. The cart is coupled to the first dual jaw pusher and the second dual jaw pusher, where movement of the cart in a vertical direction results in horizontal movement of the first jaw pusher and the second dual jaw pusher.

Example 14 includes the vise of example 13, comprising a piston located within the vise body, where the piston is coupled to the cart, and upon actuation of the piston in a vertical direction the first dual jaw pusher and the second dual jaw pusher are moved in a horizontal direction.

Example 15 includes the vise of example 13, where the first dual jaw pusher and the second dual jaw pusher each include an upper pusher and a lower pusher, where the upper pusher is movably coupled to the lower pusher at an angled sidewall interface structure, and where the angled sidewall interface structure translates vertical movement of the lower pusher to horizontal movement of the upper pusher.

Example 16 includes the vise of example 15 comprising where the lead screw extends through the lower pusher and is operably coupled to the lower pusher.

Example 17 includes the vise of example 15, where the cart is mechanically coupled to the lower pusher.

Example 18 provides a method of holding a workpiece. The method comprising providing a vise according to claim 13, and using the vise to securely hold a workpiece.

Example 19 includes the method of example 18 comprising operating the leadscrew to move the first dual jaw pusher and second dual jaw horizontally in position to hold a workpiece.

Example 20 includes the method of example 19 comprising moving the cart in a vertical direction to securely tension the workpiece, including actuating a piston to move the cart in the vertical direction.

It is to be understood that the features of the various exemplary embodiments described herein may be combined with each other, unless specifically noted otherwise. For example, the upper pusher can take on other designs other than the reversible design configuration illustrated herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A vise comprising:
a vise body;
a dual jaw pusher;
a lead screw operably coupled to the dual jaw pusher, the lead screw provides gross adjustment to positioning the dual jaw pusher;
a cart operably coupled to the dual jaw pusher; and
a piston coupled to the cart for vertical movement of the cart relative to the vise body, and where the dual jaw pusher translates vertical movement from the cart to horizontal movement of the dual jaw pusher.

2. The vise of claim 1, the dual jaw pusher comprising an upper pusher and a lower pusher, where the lower pusher is coupled to the cart.

3. The vise of claim 2, where an interface between the upper pusher and the lower pusher includes an angled sidewall interface structure.

4. The vise of claim 3, where the upper pusher is movably coupled to the lower pusher at the angled sidewall interface structure, and where the angled sidewall interface structure translates vertical movement of the lower pusher to horizontal movement of the upper pusher.

5. The vise of claim 2, the lower pusher including a side face having an angled slide member, the upper pusher including an interior sidewall having an angled slot for receiving the angled side member.

6. The vise of claim 5, the side face having a first angled sidewall, and the angled slot having a second angled sidewall, where the first angled sidewall substantially matches the second angled sidewall such that the angled slide member is movably positioned within the angled slot.

7. The vise of claim 1, where the cart extends longitudinally along a length of the vise.

8. The vise of claim 1, the dual jaw pusher including an upper pusher and a lower pusher, where the lower pusher is at least partially contained within the cart.

9. The vise of claim 8, the cart body with generally inwardly facing, u-shaped cart sidewalls, and where the lower pusher includes a lower pusher extension that fits within the u-shaped cart sidewalls.

10. The vise of claim 8, where the lead screw is operably coupled to the lower pusher.

11. The vise of claim 1, comprising a jaw operably positioned on the dual jaw pusher.

12. The vise of claim 1, the vise body including an air chamber, where the piston includes a piston head that moves vertically within the air chamber, and where the piston head is coupled to the dual pusher via the cart.

13. A vise comprising:
a vise body;
a cart system positioned within the vise body, the cart system comprising:
a lead screw;
a first dual jaw pusher and a second dual jaw pusher operably positioned on the lead screw, where upon rotation of the lead screw in a first direction the first dual jaw pusher and the second dual jaw pusher move inward for holding a workpiece;
a cart coupled to the first dual jaw pusher and the second dual jaw pusher, where movement of the cart in a vertical direction results in horizontal movement of the first dual jaw pusher and the second dual jaw pusher.

14. The vise of claim 13, comprising:
a piston located within the vise body, where the piston is coupled to the cart, and upon actuation of the piston in a vertical direction the first dual jaw pusher and the second dual jaw pusher are moved in a horizontal direction.

15. The vise of claim 13, where the first dual jaw pusher and the second dual jaw pusher each include an upper pusher and a lower pusher, where the upper pusher is movably coupled to the lower pusher at an angled sidewall interface, and where the angled sidewall interface structure translates vertical movement of the lower pusher to horizontal movement of the upper pusher.

16. The vise of claim 15, comprising:
where the lead screw extends through the lower pusher and is operably coupled to the lower pusher.

17. The vise of claim 15, where the cart is mechanically coupled to the lower pusher.

18. A method of holding a workpiece comprising:
providing a vise according to claim 13,
using the vise to securely hold a workpiece.

19. The method of claim 18, comprising:
operating the leadscrew to move the first dual jaw pusher and second dual jaw pusher horizontally in position to hold a workpiece.

20. The method of claim 19, comprising:
moving the cart in a vertical direction to securely tension the workpiece, including actuating a piston to move the cart in the vertical direction.
